(19) United States
(12) Patent Application Publication
(10) Pub. No.: US 2015/0057974 A1
(43) Pub. Date: Feb. 26, 2015

(54) METHOD OF REPRESENTING USAGE QUANTITIES OF AT LEAST ONE EXECUTION CORE AND USER TERMINAL PERFORMING THE SAME

(71) Applicant: TEEMSTONE, Seoul (KR)

(72) Inventors: Bum Sik Lee, Seongnam-si (KR); Chang Won Seol, Seongnam-si (KR); Ja Heon Ku, Seoul (KR)

(21) Appl. No.: 14/455,985

(22) Filed: Aug. 11, 2014

(30) Foreign Application Priority Data
Aug. 23, 2013 (KR) 10-2013-0100686

(51) Int. Cl. G06F 11/34; H04N 17/00

(52) U.S. Cl. CPC G06F 11/3428; H04N 17/00
USPC 702/186

(57) ABSTRACT

Disclosed is a method of representing usage quantity of an execution core. The method includes (a) receiving a specific process display mode among a plurality of process display modes, (b) measuring the usage quantities of the at least one execution core according to the specific process display mode, the usage quantities including at least one of maximum and average usage quantities or a current usage quantity for a corresponding execution core and (c) overlaidly representing the measured usage quantities at a reference point of a specific axis. Therefore, usage quantities for a process may be overlaidly represented so that the user may efficiently analyze and manage the usage quantities on a small screen.

### CROSS-REFERENCE TO RELATED APPLICATIONS

Pursuant to 35 U.S.C. §119(a), this application claims the benefit of earlier filing date and right of priority to Korean Patent Application No. 10-2013-0100686, filed on Aug. 23, 2013, the contents of which are hereby incorporated by reference herein in their entirety.

### BACKGROUND

The present invention relates to a usage representation technology of an execution core, more particularly to a method of representing usage quantities of at least one execution core and a user terminal performing the same.

Recently, a computer system performance is very rapidly developed with a development of an IT industry. A resource of the computer system is managed by an operating system. The operating system corresponds to a system software being operated as an interface between a user and a computer hardware to control an input and output of a memory, a disc and a plurality of external devices and to cause a program to usefully use a hardware. The operating system provides an execution environment (e.g., a CPU, a memory and a file system) of the program.

The Korean Patent Registration No. 10-1000100 relates to a used packet quantity providing method, a used packet quantity providing server, a used packet quantity displaying method, and a used packet quantity displaying terminal are provided to display the quantity of user packets in real time when a user uses a data service. The used packet quantity providing method proposes that a user checks the used packet quantity used by the user in real time to expect a packet charge being imposed.

The Korean Patent Registration No. 10-0989494 relates to a process management support system and so forth which support to continuously search a business process adapted to changes in an external environment are provided. The progress management support system may define a progress aspect of a plurality of client operations (COP) to exactly perform a simulation of the business process.

### SUMMARY OF THE INVENTION

Example embodiments of the present invention propose a method of representing usage quantities of at least one execution core capable of efficiently representing the usage quantities.

Example embodiments of the present invention propose a method of representing usage quantities of at least one execution core capable of overlaidly representing usage quantities to support a user for efficiently analyzing and managing the usage quantities on a small screen.

Example embodiments of the present invention propose a method of representing usage quantities of at least one execution core capable of measuring the usage quantities to provide the usage quantities to a user.

In some embodiments, a method of representing usage quantities of at least one execution core in a user terminal includes (a) receiving a specific process display mode among a plurality of process display modes, (b) measuring the usage quantities of the at least one execution core according to the specific process display mode, the usage quantities including at least one of maximum and average usage quantities or a current usage quantity for a corresponding execution core and (c) overlaidly representing the measured usage quantities at a reference point of a specific axis.

In one embodiment, the step (c) may include determining a depth layer for each of the maximum and average usage quantities and the current usage quantity. The step (c) may applying a first depth layer to the maximum usage quantity and representing the maximum usage quantity with a first width on the reference point.

The step (c) may include applying a second depth layer to the average usage quantity and representing the average usage quantity with the first width on the reference point.

The step (c) may include applying a third depth layer to the current usage quantity and representing the current usage quantity with a second width on the reference point.

In one embodiment, the first and second widths may be inversely proportional to a number of the at least one execution core. The step (c) may include sequentially representing the usage quantities on the specific axis according to a user's determining reference or a user's representing reference.

In one embodiment, the method of representing usage quantities of at least one execution core may further include (d) representing a monitoring list including a plurality of monitoring target computers being selected in the user terminal on a side of the specific axis.

The step (d) may include displaying a display layout of the measured usage quantities on each of the plurality of the monitoring target computers.

The step (b) may include determining a measurement cycle for the usage quantities based on the current usage. The measurement cycle may be determined by a following [Mathematical Equation]

M_cycle={(N1_usage)⁻¹*T}+{(N2_usage)⁻¹*T}+ . . . +{(Nn_usage)−1*T}/n [Mathematical Equation]

N1_usage: a current usage of a first execution core.

N2_usage: a current usage of a second execution core

Nn_usage: a current usage of a n-th execution core

T: a specific time

n: a number of at least one execution core

The measurement cycle may be decreased less than a reference cycle when the current usage quantity measured during a specific time is continuously increased and may be increased more than the reference cycle when the current usage quantity measured during the specific time is continuously decreased.

In some embodiments, a user terminal including at least one execution core include a process display mode inputting unit receiving a specific process display mode among a plurality of process display modes, a usage quantities measuring unit measuring usage quantities of the at least one execution core according to the specific process display mode, the usage quantities including at least one of maximum and average usage quantities or a current usage quantity for a corresponding execution core and an usage quantities representing unit configured to overlaidly the measured usage quantities at a reference point of a specific axis.

In one embodiment, the user terminal may further include a monitoring list representing unit representing a monitoring list including a plurality of monitoring target computers being selected in the user terminal on a side of the specific axis.

In some embodiment, a method of measuring usage quantities of at least one measured object in a user terminal include receiving a specific process display mode among a plurality of process display modes, measuring the usage quantities of the at least one measured object according to the specific process display mode to generate at least one of usage measurement, the usage quantities including at least one of maximum and average usage quantities or a current usage quantity for a corresponding measured object and overlaidly representing the measured usage quantities of at least one measured object at a reference point of a specific axis.

The method of representing usage quantities of at least one execution core and related technologies according to an example embodiment may efficiently represent the usage quantities.

The method of representing usage quantities of at least one execution core and related technologies according to an example embodiment may overlaidly represent usage quantities to support a user for efficiently analyzing and managing the usage quantities on a small screen.

The method of representing usage quantities of at least one execution core and related technologies according to an example embodiment may measure the usage quantities to provide the usage quantities to a user.

### BRIEF DESCRIPTION OF THE DRAWINGS

FIG. 1 is a block diagram illustrating an internal server of a user terminal according to an example embodiment of the present invention.

FIG. 2 is a flow chart illustrating a procedure of measuring usage quantities of at least one execution core being performed a user terminal in FIG. 1.

FIG. 3 is a diagram illustrating usage quantities of at least one execution core represented through a procedure of measuring usage quantities in FIG. 1.

FIG. 4 is a diagram illustrating usage quantities of at least one execution core represented through a procedure of measuring usage quantities in FIG. 1.

FIG. 5 is a diagram illustrating a representing width of usage quantities of at least one execution core represented according to a number of at least execution core of a user terminal in FIG. 1.

FIG. 6 is a diagram illustrating a monitoring list being selected in a user terminal.

### DETAILED DESCRIPTION

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps are used for the sake of explanation and do not described order of respective steps. The respective steps may be changed from a mentioned order unless specifically mentioned in context. Namely, respective steps may be performed in the same order as described, may be substantially simultaneously performed, or may be performed in reverse order.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

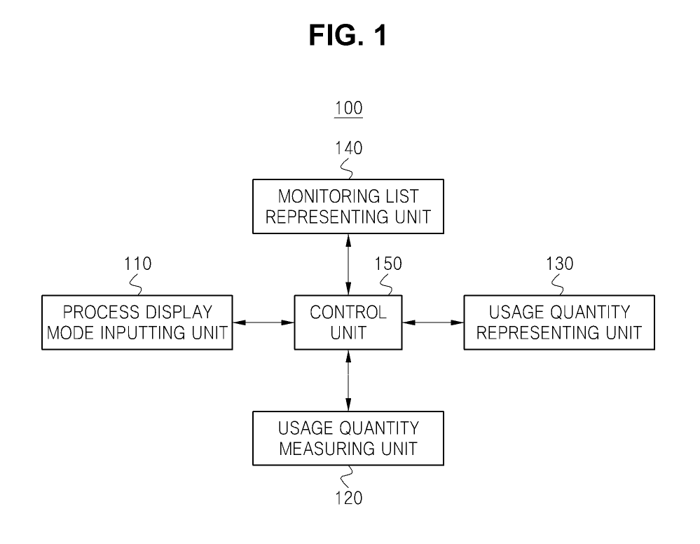

FIG. 1 is a block diagram illustrating an internal server of a user terminal according to an example embodiment of the present invention.

Referring to FIG. 1, a user terminal 100 includes a process display mode inputting unit 110, a usage quantity measuring unit 120, a usage quantity representing unit 130, a monitoring list representing unit 140 and a control unit 150.

The user terminal 100 may include a measured object being measured through usage quantities. Herein, the measured object may correspond to an execution core (i.e., central processing unit, CPU), a memory or an I/O (i.e., input/output).

Hereinafter, the user terminal 100 according to an example embodiment of the present invention includes the execution core. However, this limitation is just used for convenience's sake and should not be intended to limit the scope of the present invention. That is, the user terminal 100 may be identically performed to an object being capable of measuring the usage quantity like as the memory or the I/O.

The process display mode inputting unit 110 receives a specific process display mode among a plurality of process display modes. Herein, the plurality of the process display modes may include a user and system process display mode, a user process display mode, a system process display mode and an idle process display mode.

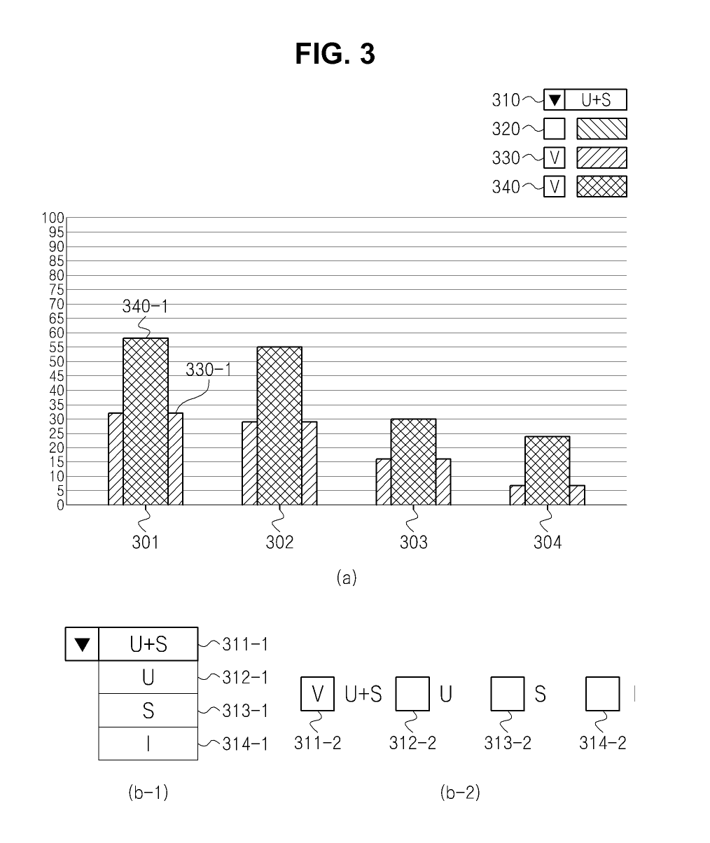

In one embodiment, the process display mode inputting unit 110 may receive the specific process display mode among the plurality of the process display modes from a user through a combo box. For example, in (b-1) of FIG. 3, when a specific event is not generated, the combo box may not display the plurality of the process display modes and when the specific event is generated, the combo box may display the plurality of the process display modes. The specific event may correspond to an event selected by the user. When a U+S(311-1) is received from the user in the combo box, the process display mode inputting unit 110 may provide the user and system process display mode, when a U(312-1) is received from the user in the combo box, the process display mode inputting unit 110 may provide the user process display mode, when a S(313-1) is received from the user in the combo box, the process display mode inputting unit 110 may provide the system process display mode and when a I(314-1) is received from the user in the combo box, the process display mode inputting unit 110 may provide the idle process display mode.

In another embodiment, the process display mode inputting unit 110 may receive the specific process display mode among the plurality of the process display modes from the user through a check box. For example, in (b-2) of FIG. 3, one check box may be selected by the user in the plurality of the check boxes. When a U+S(311-2) is received from the user in the check box, the process display mode inputting unit 110 may provide the user and system process display mode, when a U(312-2) is received from the user in the check box, the process display mode inputting unit 110 may provide the user process display mode, when a S(313-2) is received from the user in the check box, the process display mode inputting unit 110 may provide the system process display mode and when a I(314-2) is received from the user in the check box, the process display mode inputting unit 110 may provide the idle process display mode.

The usage quantity measuring unit 120 measures usage quantities of at least one execution core according to the specific process display mode. The usage quantities includes at least one of maximum and average usage quantities or a current usage quantity for a corresponding execution core. The maximum and average usage quantities and the current usage may corresponds to a range of 0% through 100%.

In one embodiment, the usage quantity measuring unit 120 may differently measure each of the usage quantities for the plurality of the process display modes. The user and system process display mode may measure the maximum and average usage quantities and the current usage quantity for each of a user process and a system (or kernel) process. The user process display mode may measure the maximum and average usage quantities and the current usage quantity for the user process. The system process display mode may measure the maximum and average usage quantities and the current usage quantity for the system (or the kernel) process. The idle process display mode may measure remaining usage quantities of an idle state being not used in the user process and the system (or the kernel) process.

In one embodiment, the usage quantity measuring unit 120 may determine a measurement cycle for the usage quantities based on the current usage quantity. The measurement cycle may be determined by a following [Mathematical Equation]

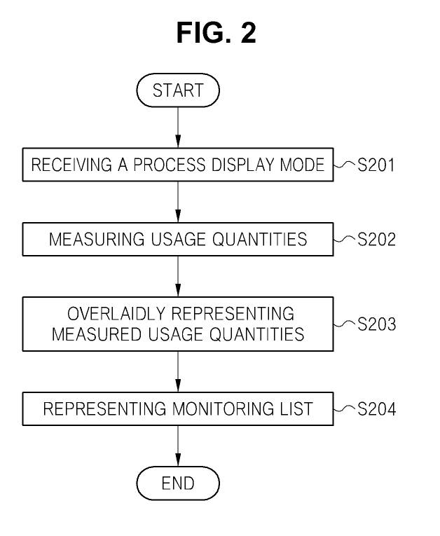

M_cycle={(N1_usage)⁻¹*T}+{(N2_usage)⁻¹*T}+ . . . +{(Nn_usage)−1*T}/n [Mathematical Equation]

[Mathematical Equation] for the measurement cycle will be described in FIG. 2.

In another embodiment, the usage quantity measuring unit 120 may check a ratio of the current usage quantity to the maximum usage quantity to determine the measurement cycle for the usage quantities. The measurement cycle may be determined by a following [Mathematical Equation]

M_cycle2={(N1_usage/M1_usage)*T}+{(N2_usage/M2_usage)*T}+ . . . +{(Nn_usage_{—}Mn_usage)*T}/n [Mathematical Equation]

[Mathematical Equation] for the measurement cycle will be described in FIG. 2.

The usage quantity measuring unit 120 may decrease the measurement cycle to less than a reference cycle when the current usage quantity measured during a specific time is continuously increased and may increase the measurement cycle to more than the reference cycle when the current usage measured during the specific time is continuously decreased. For example, when the current usage quantity is measured as 20%, 25%, 40%, 35% and 50%, the usage quantity measuring unit 120 may determine the current usage quantity on an increase trend to set the measurement cycle to less than the reference cycle. In another embodiment, when the current usage quantity is measured as 60%, 70%, 30%, 20% and 10%, 120 may determine the current usage quantity on a decrease trend to set the measurement cycle to more than the reference cycle.

The usage quantity representing unit 130 overlaidly represents the measured usage quantities at a reference point of a specific axis. Herein, the overlay term indicates superimposing the maximum and average usage quantities and the current usage quantity, each being included in the usage quantities of the at least one execution core in a specific range of a specific axis.

The usage quantity representing unit 130 may sequentially represent the usage quantities on the specific axis according to a user's determining reference or a user's representing reference. The user may set the usage quantity of the execution core as one of maximum and average representation and a current representation. The maximum representation is represented based on the maximum usage quantity, the average representation is represented based on the average usage quantity and the current representation is represented based on the current usage quantity. For example, the representing reference may correspond to the current representation.

The usage quantity representing unit 130 may determine a depth layer for each of the maximum and average usage quantities and the current usage quantity. The depth layer may be determined according to a Z-index value. When a specific Z-index value is more than a reference Z-index value, the depth layer may be arranged in front order and when the specific Z-index value is less than a reference Z-index value, the depth layer may be arranged behind.

In one embodiment, the usage quantity representing unit 130 may apply a first depth layer to the maximum usage quantity measured during the specific time and may represent a maximum usage quantity with a first width on the reference point of the specific axis, may apply a second depth layer to the average usage quantity measured during the specific time and may represent an average usage quantity with a first width on the reference point of the specific axis and may apply a third depth layer to the current usage quantity measured during the specific time and may represent a current usage quantity with a second width on the reference point of the specific axis. Herein, the first depth layer may be represented behind the second depth layer and the second depth layer may be represented behind the third depth layer. A value of the first width may be more than a value of the second width.

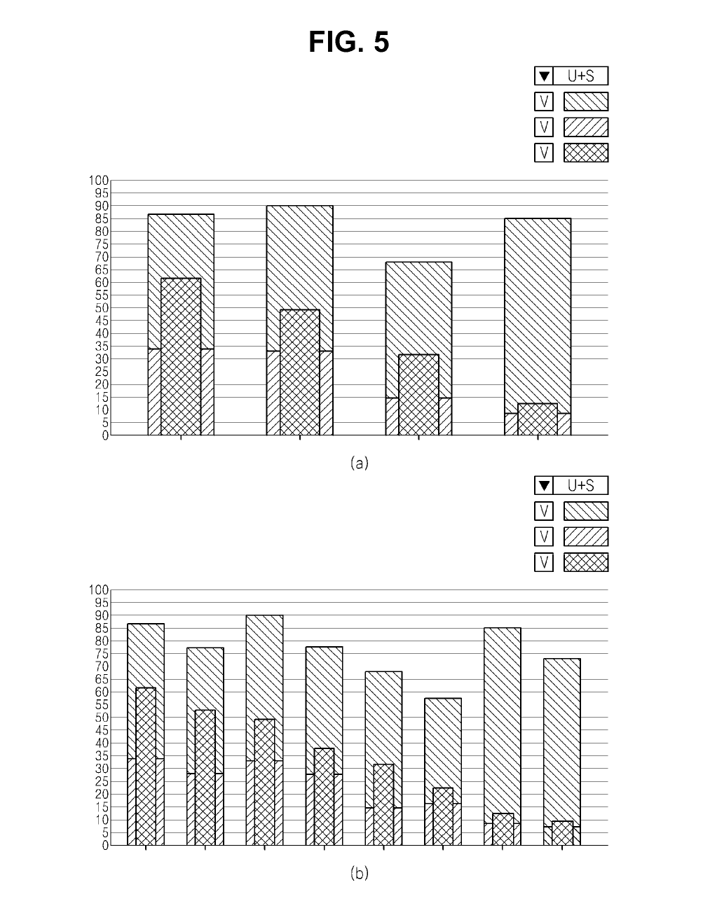

In one embodiment, the usage quantity representing unit 130 may determine the first and second widths. The determined first and second widths may be inversely proportional to a number of the at least one execution core. For example, in FIG. 5, the usage quantity representing unit 130 may vary the first width of the maximum and average usage quantities and the second width of the current usage quantity. The first width of the maximum and average usage quantities and the second width of the current usage quantity where the number of the at least one execution core is large are less than those where the first width of the maximum and average quantities and the second width of the current usage quantity when the number of the at least one execution core is small.

The monitoring list representing unit 140 represents a monitoring list on a side of the specific axis. The monitoring list includes a plurality of monitoring target computers being selected in the user terminal 100. Herein, the user terminal 100 may monitor the usage quantities of the at least one execution core for the plurality of the monitoring target computers.

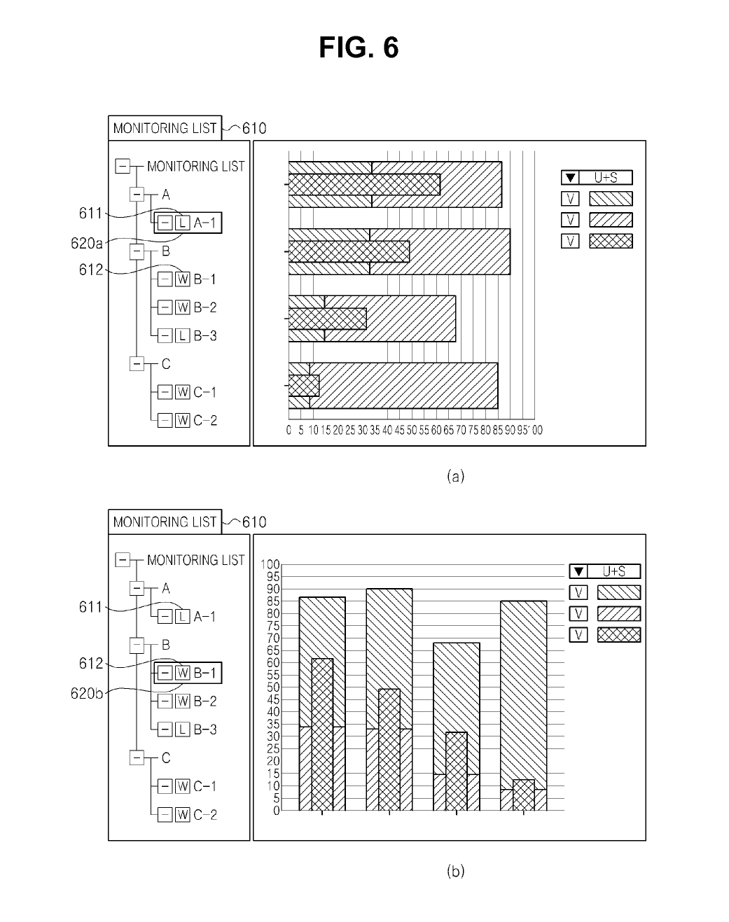

In one embodiment, when a specific monitoring target computer is selected in the plurality of the monitoring target computers, the monitoring list representing unit 140 may support the usage quantity representing unit 130 for representing the usage quantities measured in the specific monitoring target computer. For example, in FIG. 6, when a B-1 monitoring target computer 620 is selected in the monitoring list 610 by the user, the monitoring list representing unit 140 may cause the usage quantity representing unit 130 to represent the usage quantities including the maximum and average usage quantities and the current usage quantity. Herein, the represented usage quantities may be selected by the user.

The monitoring list representing unit 140 may support the usage quantity representing unit 130 so that the usage quantity representing unit 130 may represent integrated usage quantities of at least one execution core measured in the plurality of the monitoring target computers. The integrated usage quantities may include at least one an integrated maximum usage quantity, an integrated average usage quantity and an integrated current usage quantity. The integrated maximum usage quantity, the integrated average usage quantity and the integrated current usage quantity are measured in the plurality of the monitoring target computers.

The control unit 150 may control a total operation of an internal server in the user terminal 100 and may control a control flow or a data flow among the process display mode inputting unit 110, the usage quantity measuring unit 120, the usage quantity representing unit 130 and the monitoring list representing unit 140.

FIG. 2 is a flow chart illustrating a procedure of measuring usage quantities of at least one execution core being performed a user terminal in FIG. 1.

Referring to FIG. 2, the process display mode inputting unit 110 receives the specific process display mode among the plurality of the process display modes (Step S201).

In one embodiment, the process display mode inputting unit 110 may receive the specific process display mode among the plurality of the process display modes from the user through the combo box or the check box.

The usage quantity measuring unit 120 measures the usage quantities of the at least one execution core according to the specific process display mode (Step S202). The usage quantities includes at least one of maximum and average usage quantities or a current usage quantity for a corresponding execution core.

In one embodiment, the usage quantity measuring unit 120 may determine the measurement cycle based on the current usage quantity. The measurement cycle may be determined by a following [Mathematical Equation].

M_cycle={(N1_usage)⁻¹*T}+{(N2_usage)⁻¹*T}+ . . . +{(Nn_usage)−1*T}/n [Mathematical Equation]

Herein, N1_usage may correspond to a current usage quantity of a first execution core, N2_usage may correspond to a current usage quantity of a second execution core, Nn_usage may correspond to a current usage of a n-th execution core, T may correspond to the specific time and n may correspond to a number of at least one execution core. For example, assuming that a number of the execution core is 4, a current usage quantity of a first execution core measured during 60 s (i.e., the specific time) is 40%, a current usage quantity of a second execution core measured during 60 s (i.e., the specific time) is 20%, a current usage quantity of a third execution core measured during 60 s (i.e., the specific time) is 40% and a current usage quantity of a fourth execution core measured during 60 s (i.e., the specific time) is 15%, the measurement cycle may be determined as about 2.5 minute (i.e., 150 s,

$$\frac{( ( \frac{1}{40} \times 60 ) + ( \frac{1}{20} \times 60 ) + ( \frac{1}{40} \times 60 ) + ( \frac{1}{15} \times 60 ) )}{4} ) .$$

For another example, assuming that a number of the execution core is 4, a current usage quantity of a first execution core measured during 60 s (i.e., the specific time) is 60%, a current usage quantity of a second execution core measured during 60 s (i.e., the specific time) is 40%, a current usage quantity of a third execution core measured during 60 s (i.e., the specific time) is 40% and a current usage quantity of a fourth execution core measured during 60 s (i.e., the specific time) is 60%, the measurement cycle may be determined as about 1.25 minute (i.e., 75 s,

$$\frac{( ( \frac{1}{60} \times 60 ) + ( \frac{1}{40} \times 60 ) + ( \frac{1}{40} \times 60 ) + ( \frac{1}{60} \times 60 ) )}{4} ) .$$

Therefore, the measurement cycle may be inversely proportional to the current usage quantity measured during the specific time.

In another embodiment, the usage quantity measuring unit 120 may check the ratio of the current usage quantity to the maximum usage quantity to determine the measurement cycle for the usage quantities. The measurement cycle may be determined a following [Mathematical Equation].

M_cycle2={(N1_usage/M1_usage)*T}+{(N2_usage/M2_usage)*T}+ . . . +{(Nn_usage_{—}Mn_usage)*T}/n [Mathematical Equation]

Herein, N1_usage may correspond to the current usage quantity of the first execution core, M1_usage may correspond to a maximum usage quantity of the first execution core, N2_usage may correspond to the current usage quantity of the second execution core, M2_usage may correspond to a maximum usage quantity of the second execution core, Nn_usage may correspond to the current usage quantity of the n-th execution core, Mn_usage may correspond to a maximum usage quantity of the n-th execution core, T may correspond to the specific time and n may correspond to the number of at least one execution core. For example, assuming that a number of the execution core is 4, a current usage quantity of a first execution core measured during 60 s (i.e., the specific time) is 40%, a maximum usage quantity of a first execution core measured during 60 s (i.e., the specific time) is 80%, a current usage quantity of a second execution core measured during 60 s (i.e., the specific time) is 20%, a maximum usage quantity of a second execution core measured during 60 s (i.e., the specific time) is 60%, a current usage quantity of a third execution core measured during 60 s (i.e., the specific time) is 30%, a maximum usage quantity of a third execution core measured during 60 s (i.e., the specific time) is 60% and a current usage quantity of a fourth execution core measured during 60 s (i.e., the specific time) is 30%, a maximum usage quantity of a fourth execution core measured during 60 s (i.e., the specific time) is 90%, the measurement cycle may be determined as about 2.5 minute (i.e., 150 s,

$$\frac{( ( \frac{40}{80} \times 60 ) + ( \frac{20}{60} \times 60 ) + ( \frac{30}{60} \times 60 ) + ( \frac{30}{90} \times 60 ) )}{4} ) .$$

For another example, assuming that a number of the execution core is 4, a current usage quantity of a first execution core measured during 60 s (i.e., the specific time) is 20%, a maximum usage quantity of a first execution core measured during 60 s (i.e., the specific time) is 80%, a current usage quantity of a second execution core measured during 60 s (i.e., the specific time) is 15%, a maximum usage quantity of a second execution core measured during 60 s (i.e., the specific time) is 75%, a current usage quantity of a third execution core measured during 60 s (i.e., the specific time) is 30%, a maximum usage quantity of a third execution core measured during 60 s (i.e., the specific time) is 90% and a current usage quantity of a fourth execution core measured during 60 s (i.e., the specific time) is 20%, a maximum usage quantity of a fourth execution core measured during 60 s (i.e., the specific time) is 60%, the measurement cycle may be determined as about 1.7 minute (i.e., 102 s,

$$\frac{( ( \frac{20}{80} \times 60 ) + ( \frac{15}{75} \times 60 ) + ( \frac{30}{90} \times 60 ) + ( \frac{20}{60} \times 60 ) )}{4} ) .$$

Therefore, the measurement cycle may be proportional to a ratio the current usage quantity to the maximum usage quantity measured during the specific time.

The usage quantity representing unit 130 may overlaidly represent the measured usage quantities at a reference point of a specific axis (Step S203).

In one embodiment, the usage quantity representing unit 130 may apply the first depth layer to the maximum usage quantity measured during the specific time and represent the maximum usage quantity with the first width, may apply the second depth layer to the average usage quantity measured during the specific time and represent the average usage quantity with the first width and may apply the third depth layer to the current usage quantity measured during the specific time and represent the current usage quantity with the second width. Herein, the first depth layer may be represented behind the second depth layer and the second depth layer may be represented behind the third depth layer. A value of the first width may be more than a value of the second width.

For example, in FIG. 3, when the user selects the user and system process display mode 311-1 among the plurality of the process display modes 310 and checks the average usage quantity 330 and the current usage quantity 340 among the maximum usage quantity 320, the average usage quantity 330 and the current usage quantity 340, the usage quantity representing unit 130 may apply the second depth layer to the average usage quantity 330-1 to represent the average usage quantity 330-1 with the first width on the reference point 301, 302, 303 and 304 of the specific axis and may apply the third depth layer to the current usage quantity 340-1 to represent the current usage 340-1 with the second width on the reference point 301, 302, 303 and 304 of the specific axis for 4 execution core. Herein, a color and a pattern of the average usage quantity 330-1 may be differently represented with a color and a pattern of the current usage quantity 340-1.

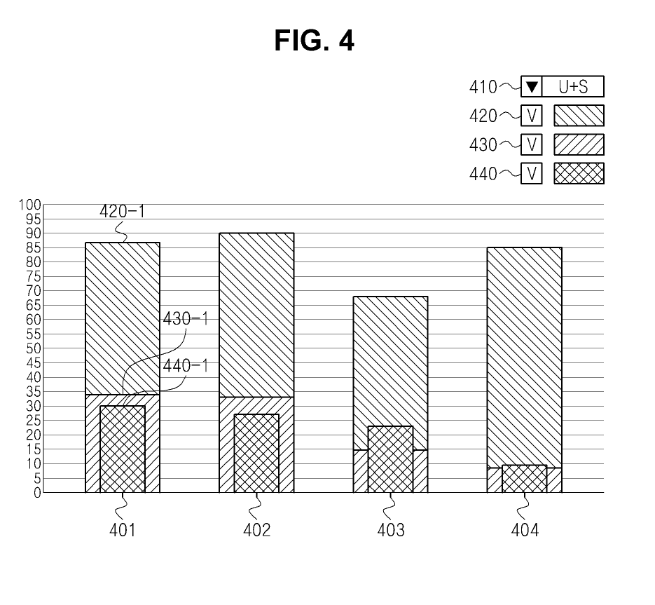

For another example, in FIG. 4, when the user inputs the user and system process display mode among the plurality of the process display modes 410 and checks all of the maximum usage quantity 420, the average usage quantity 430 and the current usage quantity 440, for 4 execution core, the usage quantity representing unit 130 may apply the first depth layer to the maximum usage quantity 420-1 to represent the maximum usage quantity 420-1 with the first width on the reference point 401, 402, 403 and 404 of the specific axis, may apply the second depth layer to the average usage quantity 430-1 to represent the average usage quantity 430-1 with the first width on the reference point 401, 402, 403 and 404 of the specific axis and may apply the third depth layer to the current usage quantity 440-1 to represent the current usage 440-1 with the second width on the reference point 401, 402, 403 and 404 of the specific axis. Herein, a color and a pattern of each of the maximum usage quantity 420-1, the average usage quantity 330-1 and the current usage quantity 440-1 may be differently represented.

The monitoring list representing unit 140 represents a monitoring list on a side of the specific axis (Step S204). The monitoring list includes the plurality of the monitoring target computers being selected in the user terminal 100. Herein, a procedure of representing the monitoring list being performed on the monitoring list representing unit 140 may not be limited in Step S204 and may be performed at one of before or after Step S201, Step S202 and Step S203.

In one embodiment, when the specific monitoring target computer is selected among the plurality of the monitoring target computers, the monitoring list representing unit 140 may support the usage quantity representing unit 130 for representing the usage quantities measured in the specific monitoring target computer. For example, in FIG. 6(b), when the user selects A-1 monitoring target computer 620a in the monitoring list 610, the monitoring list representing unit 140 may support the usage quantity representing unit 130 for representing the usage quantities (the maximum and average usage quantities and the current usage quantity) measured in the A-1 monitoring target computer 620a. For another example, in FIG. 6(b), when the user selects B-1 monitoring target computer 620b in the monitoring list 610, the monitoring list representing unit 140 may support the usage quantity representing unit 130 for representing the usage quantities (the maximum and average usage quantities and the current usage quantity) measured in the B-1 monitoring target computer 620b. Herein, the represented usage quantities may be selected by the user.

The monitoring list representing unit 140 may display a display layout of the user quantities measured for each of the plurality of the monitoring target computers. In FIG. 6, the monitoring list representing unit 140 may display a L 611 corresponding a horizontal display layout on A-1 and B-3 monitoring target computers and may display a W 612 corresponding a vertical display layout on B-1, B-2, C-1 and C-2 monitoring target computers. The horizontal and vertical display layouts of the usage quantities may be set by the user. FIG. 6(a) is a diagram illustrating an example of the horizontal display layout of the usage quantities measured for the monitoring target computer and FIG. 6(b) is a diagram illustrating an example of the vertical display layout of the usage quantities measured for the monitoring target computer.

Although this document provides descriptions of preferred embodiments of the present invention, it would be understood by those skilled in the art that the p resent invention can be modified or changed in various ways without departing fro m the technical principles and scope defined by the appended claims.

What is claimed is:

1. A method of representing usage quantities of at least one execution core in a user terminal, the method comprising:
(a) receiving a specific process display mode among a plurality of process display modes;
(b) measuring the usage quantities of the at least one execution core according to the specific process display mode, the usage quantities including at least one of maximum and average usage quantities or a current usage quantity for a corresponding execution core; and
(c) overlaidly representing the measured usage quantities at a reference point of a specific axis.

2. The method of claim 1, wherein the step (c) includes:
determining a depth layer for each of the maximum and average usage quantities and the current usage quantity.

3. The method of claim 1, wherein the step (c) includes:
applying a first depth layer to the maximum usage quantity; and
representing the maximum usage quantity with a first width on the reference point.

4. The method of claim 3, wherein the step (c) includes:
applying a second depth layer to the average usage quantity; and
representing the average usage quantity with the first width on the reference point.

5. The method of claim 4, wherein the step (c) includes:
applying a third depth layer to the current usage quantity; and
representing the current usage quantity with a second width on the reference point.

6. The method of claim 5, wherein the first and second widths are inversely proportional to a number of the at least one execution core.

7. The method of claim 1, wherein the step (c) includes:
sequentially representing the usage quantities on the specific axis according to a user's determining reference or a user's representing reference.

8. The method of claim 1, further comprising:
(d) representing a monitoring list including a plurality of monitoring target computers being selected in the user terminal on a side of the specific axis.

9. The method of claim 8, wherein the step (d) includes:
displaying a display layout of the measured usage quantities on each of the plurality of the monitoring target computers.

10. The method of claim 1, wherein the step (b) includes:
determining a measurement cycle for the usage quantities based on the current usage.

11. The method of claim 10, wherein the measurement cycle is determined by a following [Mathematical Equation]
M_cycle={(N1_usage)⁻¹*T}+{(N2_usage)⁻¹*T}+ . . . +{(Nn_usage)−1*T}/n [Mathematical Equation]
N1_usage: a current usage quantity of a first execution core.
N2_usage: a current usage quantity of a second execution core
Nn_usage: a current usage quantity of a n-th execution core
T: a specific time
n: a number of at least one execution core

12. The method of claim 10, wherein the measurement cycle is decreased less than a reference cycle when the current usage quantity measured during a specific time is continuously increased and is increased more than the reference cycle when the current usage quantity measured during the specific time is continuously decreased.

13. A user terminal including at least one execution core comprising:
a process display mode inputting unit configured to receive a specific process display mode among a plurality of process display modes;
a usage quantity measuring unit configured to measure usage quantities of the at least one execution core according to the specific process display mode, the usage quantities including at least one of maximum and average usage quantities or a current usage quantity for a corresponding execution core; and
an usage quantity representing unit configured to overlaidly the measured usage quantities at a reference point of a specific axis.

14. The user terminal of claim 13, further comprising:
a monitoring list representing unit configured to represent a monitoring list including a plurality of monitoring target computers being selected in the user terminal on a side of the specific axis.

15. A method of measuring usage quantities of at least one measured object in a user terminal, the method comprising:
receiving a specific process display mode among a plurality of process display modes;
measuring the usage quantities of the at least one measured object according to the specific process display mode to generate at least one of usage measurement, the usage quantities including at least one of maximum and average usage quantities or a current usage quantity for a corresponding measured object; and
overlaidly representing the measured usage quantities of at least one measured object at a reference point of a specific axis.
